(19) United States
(12) Patent Application Publication
(10) Pub. No.: US 2005/0127611 A1
(43) Pub. Date: Jun. 16, 2005

(54) Piston ring, especially for a vibration damper

(75) Inventor: Peter Wirth, Schonungen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/006,412

(22) Filed: Dec. 7, 2004

(30) Foreign Application Priority Data
Dec. 10, 2003 (DE) 103 57 561.8

(51) Int. Cl. F02F 5/00

(52) U.S. Cl. 277/434

(57) ABSTRACT

Piston ring, especially for a vibration damper, comprising a lateral surface, to which support segments with retaining surfaces are connected, the retaining surfaces resting on the top and bottom surfaces of a piston. Axially above and below the support segments, a sealing lip extends radially outward toward a wall against which a seal is to be formed. The sealing lip is designed radially on the inside with a reinforcing profile, the web of which is perpendicular to the support segments.

### BACKGROUND OF THE INVENTION

1. Field of the Invention

The invention pertains to a piston ring, especially for a piston in a vibration damper, including a lateral wall with a lateral surface facing the piston, a pair of retaining segments extending radially inward from the lateral surface and having respective retaining surfaces which rest against the top and bottom of the piston, and a pair of sealing lips which extend radially outward from the lateral wall for engaging a cylindrical wall of the damper.

2. Description of the Related Art

A piston ring which covers a lateral surface of a flat piston is known from US 2003/0062687. In the axial direction, the piston ring is secured by support elements with retaining surfaces, which rest on the top and bottom surfaces of the piston. Within a groove in the piston ring, a tensioning ring is provided, which is intended to pretension the piston ring radially outward against the wall of the cylinder of the vibration damper. The groove is formed by the sidewalls of webs, which extend radially inward. In this design, the problem is that the locking ring can slide out of the groove during the axial movements of the piston, which can be very rapid at times. Although it is advisable for the groove to be as deep as possible, it is difficult if not impossible to remove a piston ring with a very deep groove from the mold after the injection-molding process.

FIG. 3 of U.S. Pat. No. 5,615,756 also shows a piston ring for a flat piston, where, starting from the support segments, a comparatively massive sealing lip extends toward the inside wall. Relatively high pretensioning forces against the cylinder wall can be achieved with a massive sealing lip without the need for a tensioning ring. The presence of such a large amount of material, however, leads to distortion when the piston ring cools down after injection molding, so that the shape of the sealing lip does not always have the desired precision.

### SUMMARY OF THE INVENTION

The task of the present invention is to obtain a piston seal with a large amount of pretension against the cylinder wall.

Accomplished according to the invention in that the sealing lip is designed with a reinforcing profile radially on the inside, the web of which is perpendicular to the support segments.

The advantage of the reinforcing profile is that the wall thickness of the web does not represent a large concentration of material. In addition, it is easy to remove perpendicular webs from the mold.

Thus, for example, the sealing lip and the reinforcing profile can form a U-shaped cross section.

In another advantageous embodiment, the reinforcing profile is formed by a ring-shaped web. The sealing lip and the ring-shaped reinforcing profile are concentric and provide sufficient pretension against the cylinder wall. To simplify the design of the mold, the ring-shaped web begins directly above the support segment.

An especially high degree of dimensional rigidity can be obtained especially by providing transverse webs between the ring-shaped web and the sealing lip.

In a variant, the reinforcing profile is located axially between the support segment and the sealing lip and extends toward the surface against which the seal is to be formed. This design principle makes it possible to provide the sealing lip with very high rigidity, and at the same time the piston ring can be removed easily from the mold.

It is provided that the reinforcing profile is formed by a box profile, which is open radially toward the outside.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows how the piston ring is installed in a vibration damper;

FIG. 2 shows a piston ring on a piston; and

FIGS. 3-7 show diagrams of details of the inventive piston ring.

### DETAILED DESCRIPTION OF THE PRESENTLY PREFERRED EMBODIMENTS

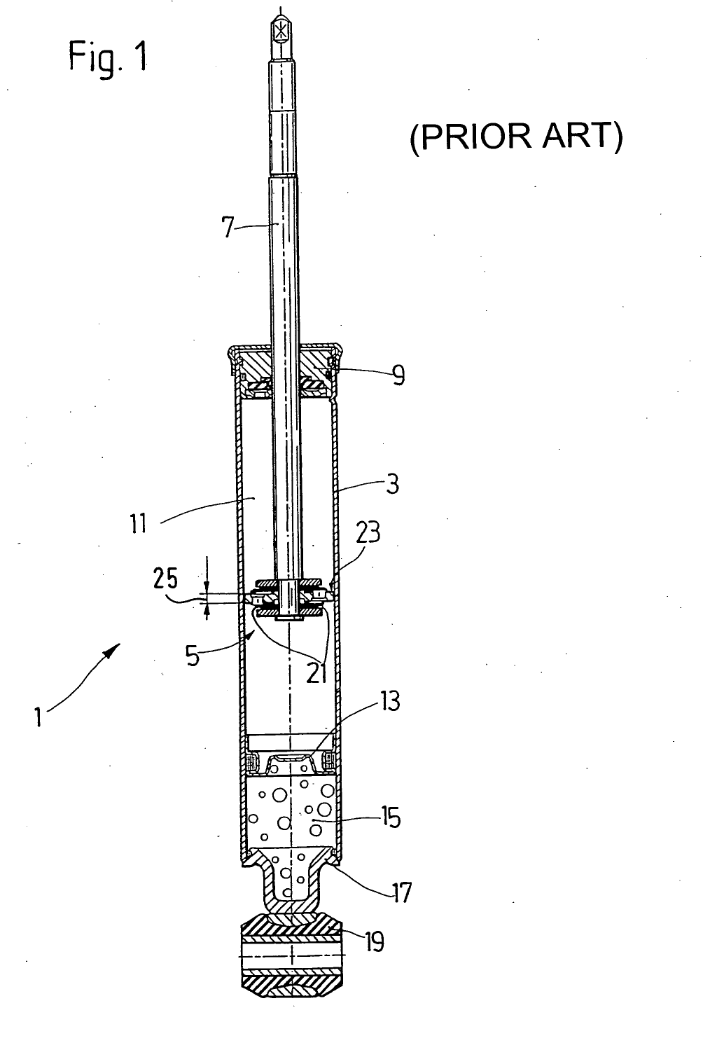

FIG. 1 shows by way of example a piston-cylinder assembly 1 in the form of a single-tube vibration damper. In principle, the invention can also be applied to other types of piston-cylinder assemblies.

The single-tube vibration damper 1 consists essentially of a pressure tube 3, in which a piston 5, mounted on a piston rod 7, is installed with freedom of axial movement. At the exit end of the piston rod 7, a piston rod guide 9 closes off a working space 11, which is filled with damping medium. This working space is separated by a separating piston 13 from a gas space 15, which has a bottom part 17 with an eye 19 at the end.

When the piston rod moves, damping medium is displaced through the damping valves 21 in the piston 5, the valves being formed by valve disks 23. A piston ring 25, which covers a circumferential surface of the piston 5, prevents the medium from flowing laterally around the piston.

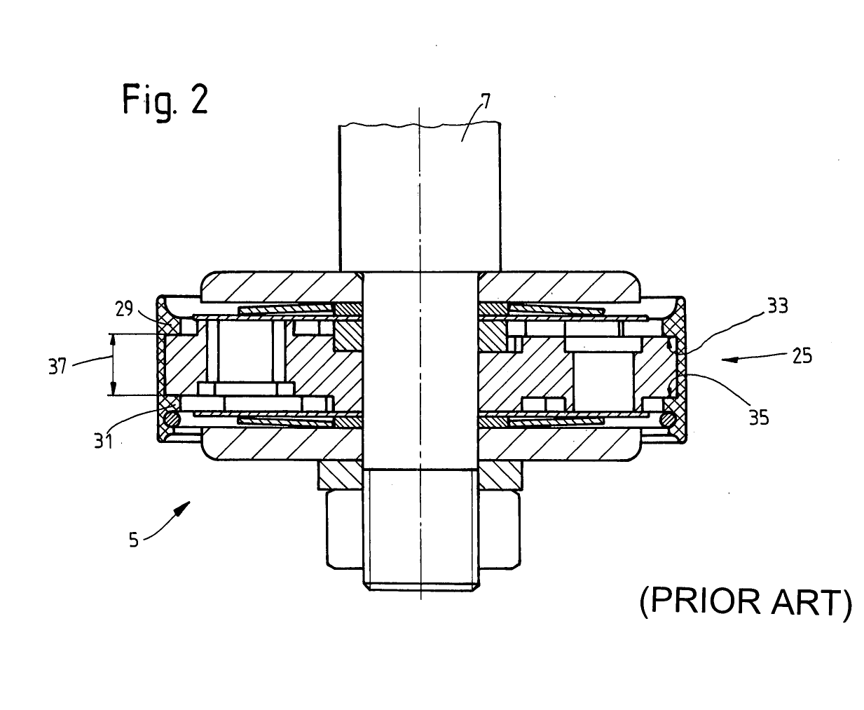

FIG. 2 shows the piston 5 on the piston rod. The piston ring 25 has a U-shaped cross section, so that, starting from the lateral surface 27 of the piston ring, the retaining surfaces 33, 35 of the support segments 29, 31 rest on the top and bottom surfaces of the piston, thus holding the piston ring 25 axially in place on the piston 5.

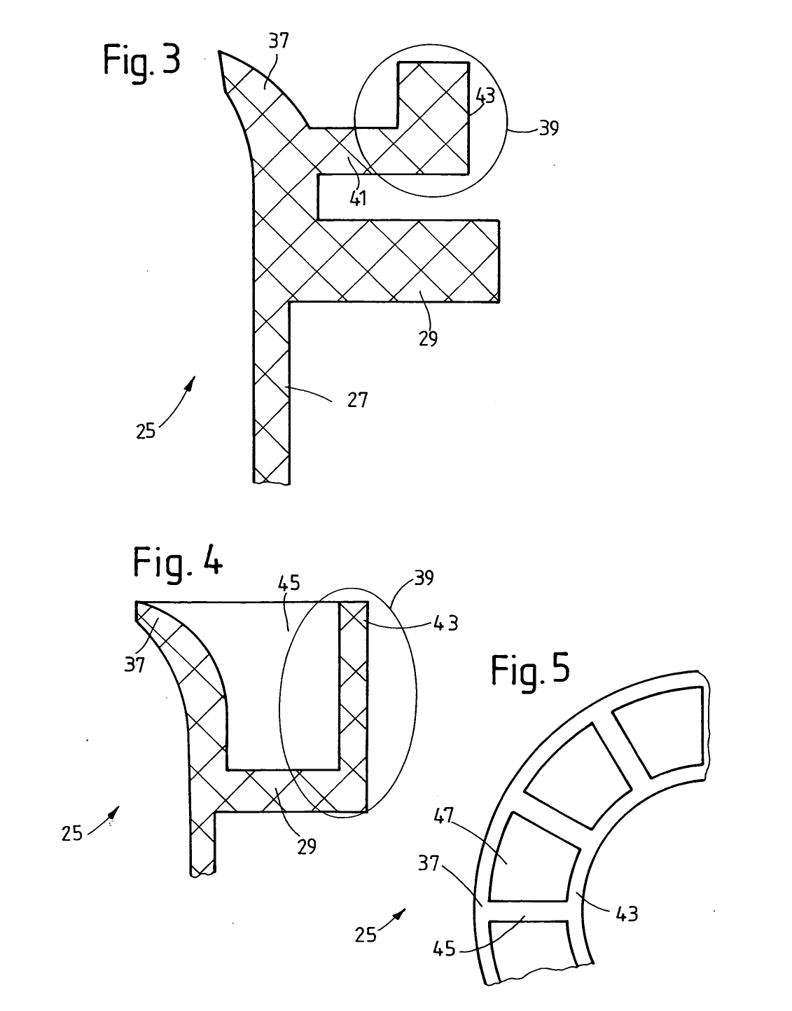

FIG. 3 shows a part of an inventive piston ring with part of the lateral surface 27 and the support segment 29. Axially above the lateral surface, a sealing lip 37 or, in the simplest case, a sealing edge, rests against the inside wall of the cylinder 3. Radially on the inside, the sealing lip is designed with a reinforcing profile 39, which, in this exemplary embodiment, has, among other things, a radially inward extending, disk-shaped web 41. This disk-shaped web 41 carries in turn a web 43, which, with respect to the support segment 29, proceeds in the axial direction, so that the sealing lip 37, the disk-shaped web 41, and the axially oriented circular ring-shaped web 43 describe a U-shaped cross section. As a result, the sealing lip 37 has a comparatively high degree of elastic stiffness while avoiding a large concentration of material. The circular ring-shaped web 43 and the radially oriented web 41 can also be divided into individual segments.

FIG. 4 shows a variant, in which the ring-shaped web 43 proceeds directly from a support segment. The sealing lip 37, the support segment 29, and the ring-shaped web 43 thus form a U-shaped profile. The sealing lip and the ring-shaped web can also be connected to each other by transverse webs 45, as a result of which the spring rate of the sealing lip is increased significantly. It can be seen in FIG. 5 that the sealing lip 37, the transverse webs 45, and the ring-shaped web 43 form pockets 47, which are filled with damping medium in the case that the application involves a vibration damper.

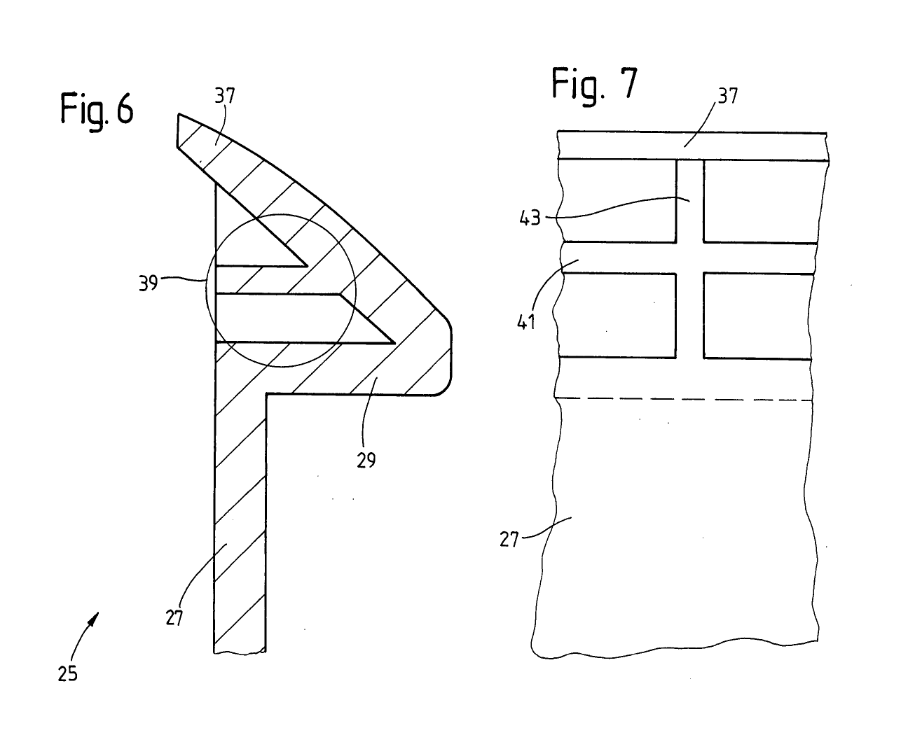

FIGS. 6 and 7 show again parts of an inventive piston ring 25, in which the reinforcing profile 39 is located axially between a support segment and the sealing lip and extends toward the surface against which the seal is to be formed. The sealing lip extends toward the cylinder 3 at a slant from the support segment 29. The reinforcing profile 39, which is designed as a box profile open radially toward the outside, is located in this space.

It is common to all the variants according to FIGS. 3-7 that the piston ring 25 is slightly oversized when it is pushed into the cylinder; as a result, its sealing lip 37 rests with pretension against the cylinder 3. This pretension is absorbed by the reinforcing profile 39. In the embodiments according to FIGS. 3-5, the stresses are essentially compressive, whereas, in FIGS. 6 and 7, they are essentially tensile. The open box profile fulfills its function in spite of the pockets present in it, because the sealing lip remains free of distortion when the piston ring cools down after the injection-molding process.

Thus, while there have shown and described and pointed out fundamental novel features of the invention as applied to a preferred embodiment thereof, it will be, understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A piston ring for a piston in a vibration damper, the piston ring comprising:
a lateral wall with a lateral surface facing the piston;
a pair of retaining segments extending radially inward from the lateral surface and having respective retaining surfaces which rest against the top and bottom of the piston;
a pair of sealing lips which extend radially outward from the lateral wall for engaging a cylindrical wall of the damper; and
a pair of radial reinforcements for respective said sealing lips, each said reinforcement comprising an axially extending web.

2. The piston ring of claim 1 wherein each said sealing lip and reinforcement have a U-shaped cross section.

3. The piston ring of claim 1 wherein the axially extending web is a ring-shaped web.

4. The piston ring of claim 3 wherein the ring-shaped web extends directly from a respective said support segment.

5. The piston ring of claim 3 further comprising transverse webs extending radially between each said ring-shaped web and a respective said sealing lip.

6. The piston ring of claim 1 wherein each said reinforcement is located axially between a respective said support segment and a respective said sealing lip and extends radially outward.

7. The piston ring of claim 6 wherein the reiforcement has a box profile which is open radially outward.
